(19) United States
(12) Patent Application Publication
(10) Pub. No.: US 2004/0056900 A1
(43) Pub. Date: Mar. 25, 2004

(54) System and method for window priority rendering

(76) Inventor: Leo R. Blume, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/251,875

(22) Filed: Sep. 23, 2002

(51) Int. Cl. G09G 5/00

(52) U.S. Cl. 345/807

(57) ABSTRACT

A method and corresponding apparatus for window priority rendering in graphical user interface (GUI) applications use filtering operations to display low priority windows, thus generating a less distracting GUI. A low priority window is a window that is not intended to receive user attention. With low priority windows displayed differently from high priority windows, a user can pay close attention to the window the user is currently using or the window to which the user's attention is intended to be directed. As a result, the user is likely to make fewer errors and to interact more efficiently with the GUI.

### TECHNICAL FIELD

The technical field relates to computer software systems, and, in particular, to systems for window priority rendering in graphical user interface (GUI) applications.

### BACKGROUND

On current computer systems, managing multiple windows in graphical user interface (GUI) applications can be difficult, especially when many windows overlap on the same screen. FIGS. 1A and 1B illustrate one class of problem associated with current window displaying system. FIG. 1B is a simplified version of the window displaying system of FIG. 1A. Referring to FIGS. 1A and 1B, windows 110, 120, 130, 140 are displayed, overlapping one another. Window 140 is a modal window. A modal window is a window that, once created, prevents user interaction with other windows. As shown in FIG. 1A, no difference exists in the rendering of the different windows, which may lead to user confusion. The current practice of uniformly rendering windows regardless of the information content or the window's position on the screen may distract the user from focusing on the window the user is currently using. Such confusion and distraction may cause the user to work more slowly and make more mistakes, such as clicking a wrong “OK” button. For example, the “OK” buttons 135 and 145 of windows 130 and 140, respectively, are rendered identically and are displayed close to each other. The proper button can be easily mistaken by the user.

### SUMMARY

A method and corresponding apparatus for window priority rendering in graphical user interface (GUI) applications include calculating and assigning window priority to a plurality of windows using priority rendering algorithms, and drawing the windows with the calculated window priority. The method also includes applying filtering operations to images in low priority windows.

The calculating and assigning process may include assigning high priority to a newly created window, a window with focus, or a modal window. The method and corresponding apparatus may assign medium priority to a window with previous high priority. Priority may also be assigned according to a window position level, a window update frequency, or a user established window focus. The drawing process may include applying filtering operation within application software, or within window system software. A post-draw function may also be used to implement the priority rendering process.

### DESCRIPTION OF THE DRAWINGS

The preferred embodiments of the method and apparatus for window priority rendering will be described in detail with reference to the following figures, in which like numerals refer to like elements, and wherein:

FIGS. 1A and 1B illustrate one class of problem associated with current window displaying systems;

FIG. 2 illustrates exemplary hardware components of a computer that may be used in connection with the method for window priority rendering in graphical user interface (GUI) applications;

FIG. 3 is a flow chart illustrating the method for window priority rendering in GUI applications; and

FIGS. 4 and 5 illustrate exemplary windows generated by the method for window priority rendering in GUI applications.

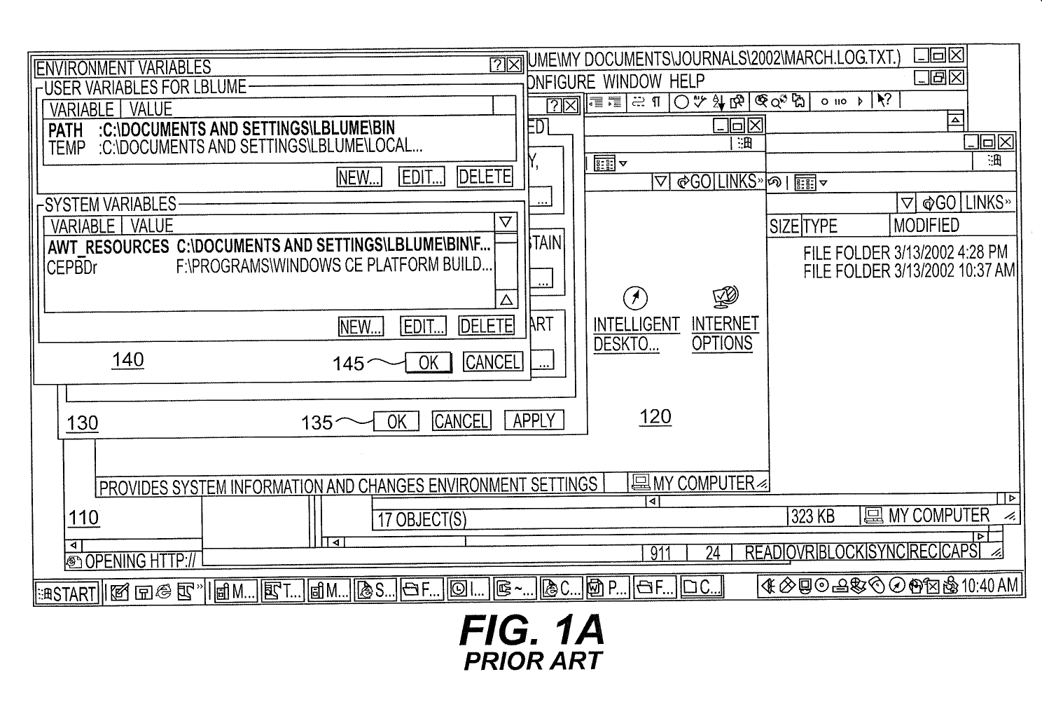

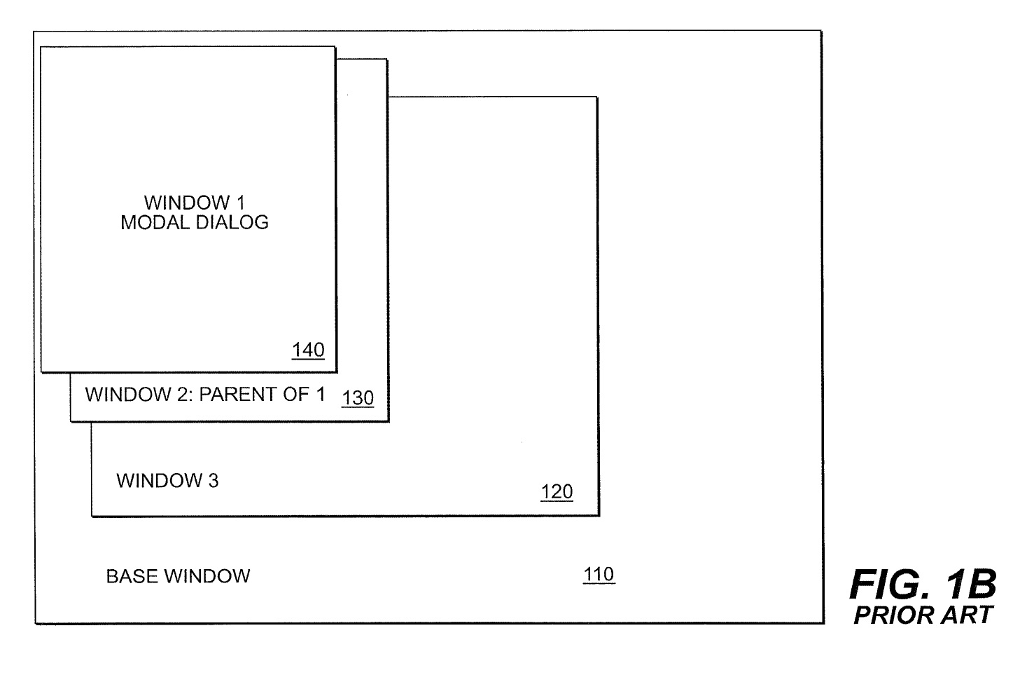

### DETAILED DESCRIPTION

A method and corresponding apparatus for window priority rendering in graphical user interface (GUI) applications use filtering operations to display low priority windows, thus generating a less distracting GUI. A low priority window is a window that is not intended to receive user attention. With low priority windows displayed differently from high priority windows, a user can pay close attention to the window the user is currently using or the window to which the user's attention is intended to be directed. As a result, the user is likely to make fewer errors and to interact more efficiently with the GUI.

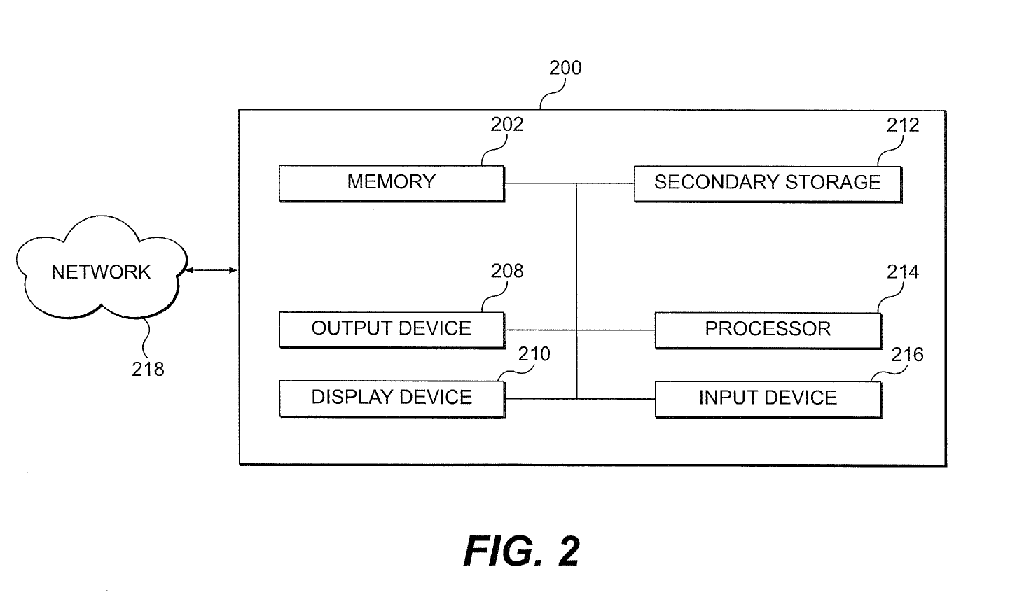

FIG. 2 illustrates exemplary hardware components of a computer 200 that may be used in connection with the method for window priority rendering in GUI applications. The computer 200 may include a connection with a network 218 such as the Internet or other type of computer or telephone network. The computer 200 typically includes a memory 202, a secondary storage device 212, a processor 214, an input device 216, a display device 210, and an output device 208.

The memory 202 may include random access memory (RAM) or similar types of memory. The secondary storage device 212 may include a hard disk drive, floppy disk drive, CD-ROM drive, or other types of non-volatile data storage, and may correspond with various databases or other resources. The processor 214 may execute information stored in the memory 202, the secondary storage 212, or received from the Internet or other network 218. The input device 216 may include any device for entering data into the computer 200, such as a keyboard, keypad, cursor-control device, touch-screen (possibly with a stylus), or microphone. The display device 210 may include any type of device for presenting visual image, such as, for example, a computer monitor, flat-screen display, or display panel. The output device 208 may include any type of device for presenting data in hard copy format, such as a printer, and other types of output devices including speakers or any device for providing data in audio form. The computer 200 can possibly include multiple input devices, output devices, and display devices.

Although the computer 200 is depicted with various components, one skilled in the art will appreciate that the computer 200 can contain additional or different components. In addition, although aspects of an implementation consistent with the method for window priority rendering are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 200 to perform a particular method.

Various terms to be used in this description are defined as follows, the term including: window stacks, modal windows, focus and update.

Windows displayed on computer screens may be organized into window stacks. A window stack is defined as the set of windows that descend from (are children of) an application main or base window. Such descendent window are sometimes referred to as sub-windows of the main window. A window stack includes all the direct sub-windows of the main window and all the descendent windows of those direct sub-windows.

Different computers have different capabilities for displaying window stacks. For example, a desktop computer may display multiple concurrent window stacks, with the top window being the window receiving user focus. On smaller handheld computers, only a single window stack may be displayed at one time.

A modal window is a window that restricts user access to or interaction with other windows. A modal window may be either an application modal window or a system modal window. An application modal window prevents interaction with other windows in the same application. A system modal dialog window prevents interaction with any other windows on the computer.

A modal window is a window that restricts user access to, or interaction with, other windows. A modal window may be either an application modal window or a system modal window. An application modal window prevents interaction with other windows in the same application. A system modal window prevents interaction with any other windows on the computer.

A window in which the user is typing is typically the window with focus though other user interfaces including eye-tracking and voice navigation techniques, may be used to establish window focus. With respect to eye-tracking techniques, the window that the user is actually looking at may be designated the window with focus. With respect to voice navigation techniques, the user may speak the name of a window that is to receive input focus. For example, in a stock trading application, the user may say “ticker” to bring up the ticker window, giving the window input focus.

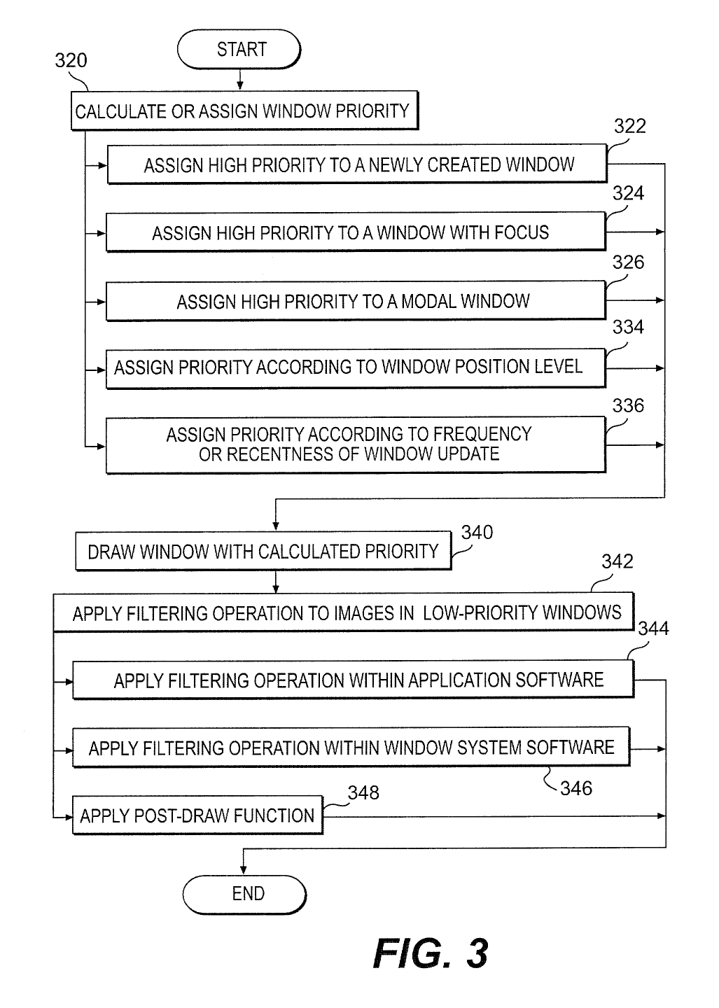

Window update is the process by which the contents of a window are drawn. Other terms for window update may include: paint, repaint, refresh and render. One skilled in the art will appreciate that other synonymous terms may be used with the window update process. Windows updates are triggered by events. Examples of such update events include: a new window being created, a part of a window being uncovered by another window, content changes within a window, and a window receiving “focus.” Events triggering window update may be time-based such that a window may be redrawn at some interval of time. Many other actions can cause a window to be redrawn. As described below, for example, a priority change in one window may cause the priority of other windows to change, thus triggering a chain of window redraws. When an update event is passed to an application function responsible for drawing the window, the processor 214 redraws the window receiving such event. FIG. 3 is a flow chart illustrating the method for window priority rendering in GUI applications. The basic process includes high-level steps of: calculating window priority and then drawing with the calculated priority. In the paragraphs that follow, methods for computing priority are described.

Though window priority may be determined using different techniques, window priority, as previously noted, is a measure of its relevance to the user. Windows that the user is actively using will typically have the highest priority. Windows that are buried under other windows or that, though not covered by other windows, are not receiving user attention will typically receive lower priority. Details of this follow.

A window that is the parent of a modal window is usually buried beneath the modal window in a window stack and thus, may have lower priority than the modal window. Additionally, a window that is mostly obscured or buried deeply in a window stack, or a window that has not been moved or typed in for a while may have a low priority. The different techniques for determining window priority may be used alone or in combination. Since priority may be a function of time, a window's priority may be slowly downgraded from lack of use. One skilled in the art will appreciate that other techniques can be used to establish a metric for window priority.

Though there will be typically one window having the highest priority, some systems may have multiple high priority windows. This may include systems with multiple displays (often accessed by multiple, simultaneous users) or systems in which more than one window displays information that is of substantial importance.

After an update event occurs that requires windows to be drawn or redrawn, the processor 214 calculates the window priority (block 320). The processor 214 may use an algorithm for calculating a window's priority. The algorithm typically depends on the number of priority levels. Window priority may be expressed as a binary value, for example, low and high. Alternatively, window priority may be expressed as a numeric range with arbitrary precision. With a two-level priority scheme, the processor 214 may assign high priority to a newly created window (block 322), a window with focus (block 324), or a modal window (block 326). Then the processor 214 may assign low priority to all other windows. The following are exemplary two-level priority calculation algorithms.

### EXAMPLE 1

Upon new window creation

The new window is assigned high priority

All other windows are assigned low priority

### EXAMPLE 2

Upon change of focus

The window with the focus is assigned high priority

All other windows are assigned low priority

### EXAMPLE 3

Upon creation of a modal window

New modal window is assigned high priority

All other windows are assigned low priority

With a multi-level priority scheme, after assigning high priority to a window, the processor 214 may assign medium priority to a previous high priority window, and downgrade other windows' priority accordingly. The following is an exemplary three-level priority calculation algorithm. In this example, window A is a newly created window.

Window A gets high priority

Assign medium priority to the previous high priority window

Downgrade all other windows to low priority

In another priority assignment scheme, the processor 214 may assign priority based on the relative positions of the windows in the window stack (block 334). For example, overlapping windows in a window stack may be assigned different position levels, with 1 being the level for a top-level window, and N being the level of a window that is N levels down from the top-level window in the window stack. One technique for assigning window priorities is to assign the window position level as the priority for each window in the window stack. Therefore, in this example, the window with position level 3 will have a priority three. The following is an exemplary algorithm for assigning priority according to window position level.

For each window stack:

For each window in the window stack:

Priority = window level

Multiple top-level windows may exist in multiple window stacks, with one top-level window per window stack. The processor 214 may reserve a special priority, for example, priority zero, for the single top-level window that has the current focus, because this is typically the window that is the top-level window of all windows on the computer (that is, of all windows in a global window stack). The following is an exemplary algorithm for such special assignment.

For each window stack:

For each window in the window stack:

If window has focus

Window priority = highest overall priority

else

Priority = window level

The algorithms discussed above can apply to windows without consideration of application semantics. In other words, these techniques are applied to windows based solely on factors such as the windows' relative position level in a window stack, and not based upon what the windows are displaying. Other techniques may apply priorities based on application considerations. For example, an application that displays several non-overlapping windows may determine window priority based on the window that is being updated most frequently or most recently (block 336). In other words, the application keeps track of what happens with windows and adjusts the windows' priorities accordingly. For example, the software in an online trading application may set a stock ticker window to a higher priority than a window that displays news articles for a selected company.

As noted, window focus can be used to establish which window has the highest priority. And though in current computers, focus is usually established by means of a mouse click or key press (usually a tab, return or arrow key), priority may also be established by other techniques. In conjunction with eye-tracking technology, an exemplary algorithm for priority setting is as follows.

Window with focus=window containing the X,Y position of the user's gaze.

Set this window to be the highest priority window.

For all other windows:

Adjust downward the priority based on the distance to the center of the user's gaze.

After calculating the window priority, the processor 214 draws the window with calculated priority, rendering high priority windows differently than lower priority windows (block 340). Such rendering makes the high priority window more visible than the other windows in the system, therefore reducing distraction caused by the other windows. Different rendering techniques may be used alone or in combination. The processor 214 typically applies various filtering operations to the image appearing in a low priority window (block 342). Exemplary filtering operations may include: lowering spatial resolution, reducing color saturation, reducing contrast, and reducing brightness of the window. One skilled in the art will appreciate that other filtering techniques may be used with the priority rendering process.

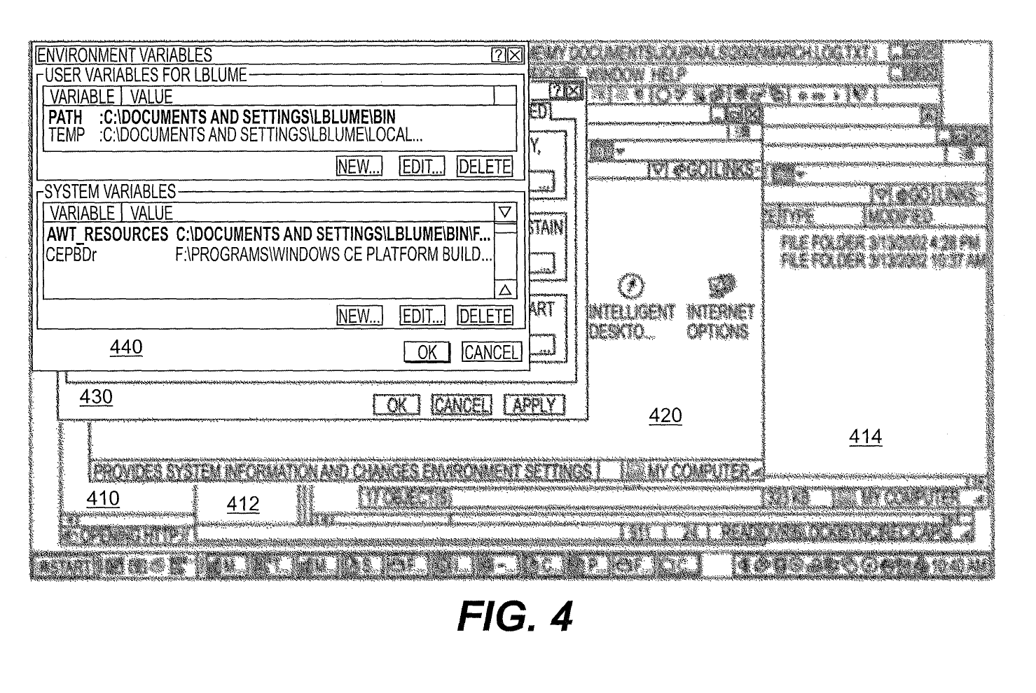

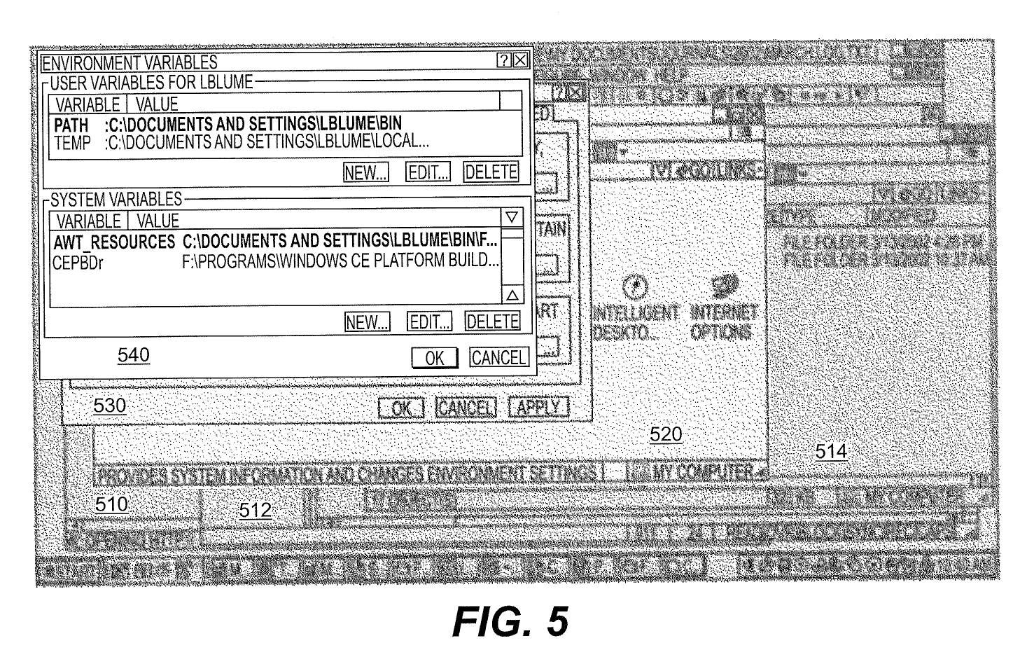

FIGS. 4 and 5 illustrate exemplary windows generated by the different priority rendering techniques. Referring to FIG. 4, soft-focus effect technique is used for low priority windows, which reduces spatial resolution of the low priority windows. High priority window 440 is the only window with high clarity, whereas windows 430, 420, 414, 412, 410 are shown with decreased resolution. Referring to FIG. 5, brightness reduction technique is combined with soft-focus effect technique to reduce brightness level of the low priority windows in addition to resolution reduction. These techniques, used alone or in combination, typically draw the users attention to the most important windows.

The filtering operations for creating the priority drawing effect can be performed either within application software (block 344 of FIG. 3) or within window system software (block 346). Within application software, one technique is to pass priority information to an application routine responsible for drawing windows, such as a window draw routine. In particular, this technique alters the basic window draw routine, and supplies the routine with a priority parameter. The draw routine then renders the windows differentially according to priority. The following is an exemplary priority parameter added to the basic window draw routine where ellipsis indicate the standard arguments to such routines.

draw (priority, . . . )

Alternately, rather than determining a window's priority prior to any drawing, a window may be drawn at arbitrary priorities, either high or low, and then be redrawn at the correct priorities.

One technique is to perform the normal draw routine for a window at, for example, high priority. Then, a post-draw function is performed based on window priority (block 348). The following is an exemplary algorithm demonstrating this technique.

draw ( . . . )

priorityFilterDraw (priority, . . . )

The post-draw function (priorityFilterDraw) can be implemented by the application or by the window system. Regardless of where the function is implemented, the post-draw function can be initiated either by the application itself or by the window system.

An alternative to drawing a single window at some arbitrary priority and then redrawing the window at the correct priority, all windows may be drawn first at some given priority and then selectively redrawn at the correct priority. Note that since the normal draw function causes a window to be drawn normally, i.e., with full clarity (effectively high priority), such windows do not have to be redrawn with high priority since that would be an unnecessary duplication of effort.

Even with the aforementioned optimization, separating the priority-based drawing into two functions, i.e., normal draw routine and post-draw function, may potentially result in duplicated effort, because each pixel may be drawn twice for low priority windows. However, the priority redraw can be performed using highly optimized window system code to improve efficiency. For example, the window system may be equipped with highly optimized code that can quickly redraw a window at lower resolution. The window system may interface with special hardware on the computer that performs such filtering operations quickly, by processing batches of windows at once. Efficiency may also be improved by reducing the number of times the graphics state needs to be changed to accomplish differences in drawing operations.

Though for many standard applications (like word processors) it is not usually faster for an application to draw a low priority window than a high priority window, there are some cases where it is faster. One such example is when windows contain images that are the output of a computationally intensive computer graphics process. In these cases, providing the application software with the knowledge that a window can (and should) be drawn with low priority frees the application from performing all the difficult and time consuming operations that would be necessary to render a high quality (high priority) image for that window. One example shortcut is to reduce the level-of-detail for the graphics rendering. Reductions in level-of-detail include using geometric models with fewer vertices and using smaller (lower resolution) texture maps. One skilled in the art will appreciate that other techniques exist which can take advantage of a reduced need for high quality imagery in windows that are designated as low priority. Thus, in some cases, the window priority rendering yields not only a benefit in terms of user cognition but also a benefit in terms of screen update efficiency and speed.

The prime benefit of the two-step procedure (draw followed by post-draw) is that when the post-draw function is implemented in the window system, the two-step technique permits applications to utilized priority-based rendering without any special effort to adapt the applications. This represents a significant convenience to the software developer.

The previous discussion assumes that all window priorities have been calculated before any drawing begins. However, it is also possible to use an incremental algorithm in which a subset of the windows have a priority calculation done and then drawing is performed on this subset. Later, other window priorities are calculated and other windows are drawn with the calculated priority. One approach would be to start with the application that contains the window with the focus since this is typically the highest priority window. This window can be immediately drawn with high priority (full resolution, for example.) Then other windows in the application can be drawn in order, for example, of decreasing priority. After all windows of this first application have been rendered at their calculated priorities, priority calculation and drawing may commence in similar fashion on the windows of other applications. This is just one possible scheme to illustrate the notion of incrementally calculating priority and drawing windows.

In addition, normal operation of window clipping operations may be used in connection with the method for window priority rendering. Window clipping normally occurs in window systems and has the effect of both correctly presenting overlapping windows and preventing unnecessary drawing to areas that will not be seen by the user.

The priority rendering scheme may be a permanent feature of an application or a window system. Alternatively, the scheme may be enabled or disabled by the user. The priority scheme may have a default number of priority levels, with an option for the user to select a higher or lower number of priority levels. Similarly, a particular priority rendering technique, i.e., filtering operation, may be set by default or selected by the user. For example, one user may want to use a brightness reduction technique to designate low priority windows, whereas another user may choose a soft-focus effect for low priority windows, as illustrated in FIG. 4. A third user may choose both techniques in combination, as illustrated in FIG. 5.

While the method and apparatus for window priority rendering have been described in connection with an exemplary embodiment, those skilled in the art will understand that many modifications in light of these teachings are possible, and this application is intended to cover any variations thereof.

What is claimed is:

1. A method for window priority rendering in graphical user interface (GUI) applications, comprising:
calculating and assigning window priority to a plurality of windows using priority rendering algorithms;
drawing the windows with the calculated window priority; and
applying filtering operations to images in low priority windows.

2. The method of claim 1, wherein the calculating and assigning step includes assigning high priority to a newly created window.

3. The method of claim 1, wherein the calculating and assigning step includes assigning high priority to a window with focus.

4. The method of claim 1, wherein the calculating and assigning step includes assigning high priority to a modal window.

5. The method of claim 1, wherein the calculating and assigning step includes assigning medium priority to a window with previous high priority.

6. The method of claim 1, wherein the calculating and assigning step includes assigning priority according to a window position level.

7. The method of claim 1, wherein the calculating and assigning step includes assigning priority according a window update frequency.

8. The method of claim 1, wherein the calculating and assigning step includes assigning priority according to a user established window focus.

9. The method of claim 1, wherein the applying step includes applying filtering operations within application software.

10. The method of claim 1, wherein the applying step includes applying filtering operations within window system software.

11. The method of claim 1, wherein the drawing step includes applying a post-draw function.

12. An apparatus for window priority rendering in graphical user interface (GUI) applications, comprising:
means for calculating and assigning window priority to a plurality of windows using priority rendering algorithms;
means for drawing the windows with the calculated window priority; and
means for applying filtering operations to images in low priority windows.

13. The apparatus of claim 12, wherein the means for applying include means for applying filtering operations within application software.

14. The apparatus of claim 12, wherein the means for applying include means for applying filtering operations within window system software.

15. A computer readable medium providing instructions for window priority rendering in graphical user interface (GUI) applications, the instructions comprising:
calculating and assigning window priority to a plurality of windows using priority rendering algorithms;
drawing the windows with the calculated window priority; and
applying filtering operations to images in low priority windows.

16. The computer readable medium of claim 15, wherein the instructions for calculating and assigning include instructions for assigning high priority to a newly created window.

17. The computer readable medium of claim 15, wherein the instructions for calculating and assigning include instructions for assigning high priority to a window with focus.

18. The computer readable medium of claim 15, wherein the instructions for calculating and assigning include instructions for assigning high priority to a modal window.

19. The computer readable medium of claim 15, wherein the instructions for applying include instructions for applying filtering operations within application software.

20. The computer readable medium of claim 15, wherein the instructions for applying include instructions for applying filtering operations within window system software.
